(19) United States
(12) Patent Application Publication
(10) Pub. No.: US 2010/0310879 A1
(43) Pub. Date: Dec. 9, 2010

(54) Skid resistant coating for metal surfaces and method of application

(76) Inventor: Jack H. Wilson, SR., Ridgeland, MS (US)

Correspondence Address: MEREK, BLACKMON & VOORHEES, LLC, 673 S. WASHINGTON ST., ALEXANDRIA, VA, 22314, US

(21) Appl. No.: 12/457,393

(22) Filed: Jun. 9, 2009

(51) Int. Cl. B32B 15/092; B05D 3/00; B32B 27/08

(52) U.S. Cl. 428/416; 427/386; 427/327; 428/414

(57) ABSTRACT

A coating for metal ship decks that provides skid resistance and corrosion protection using a polymer emulsion and aggregate layer over an epoxy layer and sealing the polymer emulsion and aggregate layer with xylene.

A method of application of an epoxy layer prior to application of the polymer emulsion to provide a corrosion resistant layer beneath the cementitious coating and then applying a xylene sealant to the cementitious coating.

### FIELD OF THE INVENTION

The present invention relates to skid and slip resistant coatings for metal decks and walkways on ships and boats and methods of application of polymer emulsions and aggregate as well as formulations of the polymer emulsion.

### BACKGROUND OF THE INVENTION

Ships and boats have decks and walkways which are frequently wet and need to be coated with a skid resistant material to prevent slipping. Pitching of the boat due to waves and sea spray makes it difficult to walk around on the deck. Over the years coatings have been developed to provide a non-skid surface. These methods have included using a paint mixture combined with aggregate such as sand to create a rough surface. Typically, epoxy has been used for the coating, however epoxy is severely deteriorated by exposure to ultraviolet light and due to it's limited re-coat period, epoxy is not repairable. Epoxy that has breeched due to ultraviolet light must be completely removed. Removal is done at a cost of hundreds of thousands of dollars on naval vessels every 2 to 3 years

However, it has been found that a high friction coefficient can be obtained through the use of improved application equipment and a modified cementitious polymer emulsion as will be described herein. Furthermore, through the use of application techniques as will be described, the friction coefficient can be applied to specific areas of the surface such as heavily traveled areas to refurbish the surface as needed. Additional objects and advantages of the invention will become apparent upon reading of the detailed description of the invention in conjunction with the accompanying drawings.

### OBJECTS AND SUMMARY OF THE INVENTION

It is an object of the invention to provide an improved skid resistant coating for the metal decks and walkways of ships and boats by the application of a polymer emulsion and aggregate; and

Another object of the invention is to provide a primer of epoxy material under the polymer emulsion for prevention of corrosion; and,

Yet another object of the invention is to provide a top coat of xylene over the polymer emulsion and aggregate as a sealant; and,

Still another object of the invention is to provide a repairable skid resistant coating which can be used on metal decks of ships and boats.

Another object of the invention includes application of the coating by spraying the polymer emulsion with aggregate to provide a skid-resistant surface.

In summary, the preferred embodiment of the invention relates to a coating for metal ship decks that provides skid resistance and corrosion protection using a cementitious polymer emulsion and aggregate over an epoxy layer and sealing the cementitious layer with xylene.

Another embodiment of the invention includes the method of application of an epoxy layer prior to application of the cementitious polymer emulsion to provide a corrosion resistant layer beneath the cementitious coating and then applying a xylene sealant to the cementitious coating.

### BRIEF DESCRIPTION OF THE DRAWINGS

FIG. 1 is a top plan view of a portion of a boat deck showing the application of the materials; and,

FIG. 2 is an enlarged cross-sectional view showing the layers of material.

### DETAILED DESCRIPTION OF THE PREFERRED EMBODIMENT OF THE INVENTION

This invention is primarily directed to the sealing and resurfacing of ship decks and walkways to provide skid-resistant surfaces in a marine environment. The equipment used to apply the polymer emulsion and aggregate creates a thin layer over the deck that results in a high friction surface. The sealant composition in the form of a polymer emulsion permits a very thin layer to be applied to deck surfaces, which when dry forms a hard and durable coating. The polymer emulsion is preferably a cementitious material. An example of the polymer emulsion is described in my co-pending U.S. patent application Ser. No. 12/155,875, filed Jun. 11, 2008 and that application is incorporated herein by reference in its entirety. The aggregate used could be sand, crushed walnut shells, iron filings or similar materials which can create skid resistance.

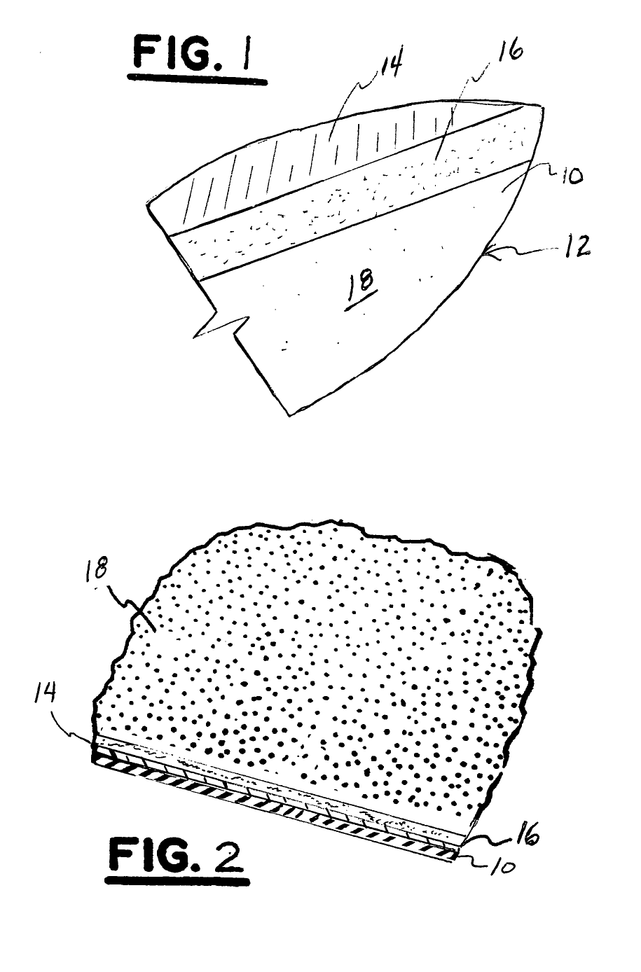

Now with reference to the FIGS. 1 and 2, a deck 10 of a ship 12 is shown. The first step requires cleaning the metal deck 10 to an SP-10 specification and remove all dust and contaminants. Next a portion of the deck 10 is preferably coated with an epoxy 14. The preferred epoxy is a two-part mixture which is specifically formulated to be applied to metal such as steel decks of ships. The preferred epoxy is either International Paint brand epoxy or Sherwin-Williams Macropoxy.

When the epoxy 14 is dry to the touch after 2 to 4 hours, the polymer emulsion and aggregate layer 16 is preferably applied by a sprayer applicator. The sprayer applicator is described in my co-pending U.S. patent application Ser. No. 11/790,505 filed on Apr. 26, 2007 and that application is incorporated herein by reference in its entirety.

The polymer emulsion and aggregate layer 16 is applied in two coats applied about one hour apart. The polymer emulsion and aggregate layer 16 is allowed to dry for one day. Next, preferably a xylene sealer 18 is applied over the polymer emulsion and aggregate layer 16 to seal the layer 16 from salt water and also from fuel spills. The xylene sealer 18 preferably includes a pigment to provide any color desired. For example, titanium dioxide may be added to the xylene sealer 18 to provide a white surface and chromium for yellow pigment. Other known coloring agents may be added to create other colorings.

A cementitious coating applied directly over raw metal may have a tendency to cause rust due to the moisture in cement. Therefore the epoxy is used as a primer to alleviate the risk. Epoxy however is severely deteriorated by ultraviolet light and due to it's limited re-coat period, it is not repairable. Epoxy that has breeched due to ultraviolet light must be completely removed. By applying the polymer emulsion and aggregate layer 16 over the epoxy 14, ultraviolet light damage is eliminated since the epoxy 14 is no longer exposed to sunlight and a long term, durable, non-skid surface is provided that is repairable because the polymer emulsion and aggregate layer 16 has no re-coat time limit.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

I claim:

1. A method of creating a skid resistant coating over a metal deck comprising the steps of:
a) applying a layer of epoxy to the metal deck and allowing said epoxy layer to dry;
b) applying a coating of polymer emulsion and aggregate layer over the epoxy layer and allowing said emulsion to dry; and
c) applying a xylene sealer over said emulsion and allowing to dry.

2. The method as set forth in claim 2, wherein:
a) said step of applying said polymer emulsion and aggregate layer includes applying said layer in two coats.

3. The method as set forth in claim 1 wherein:
a) said xylene sealer is pigmented.

4. The method as set forth in claim 1, further comprising the step of:
a) cleaning the metal deck prior to application of said epoxy.

5. The method as set forth in claim 1 wherein:
a) said polymer emulsion and aggregate layer is applied by a sprayer.

6. The method as set forth in claim 1 wherein:
a) said xylene is applied by a roller.

7. The method as set forth in claim 1 wherein:
a) said epoxy is applied by a roller.

8. A skid resistant coating for metal surfaces, comprising:
a) a layer of epoxy applied directly to the metal surface;
b) a layer of polymer emulsion and aggregate over the epoxy layer; and
c) a xylene sealer over said polymer emulsion and aggregate layer.

9. The skid resistant coating as set forth in claim 8, wherein:
a) said xylene sealer is white.

10. The skid resistant coating as set forth in claim 8, wherein:
a) said aggregate is sand.

11. A skid resistant coating for use in a marine environment, comprising:
a) a first layer of sealant applied directly to a surface which can seal out water and air from the surface;
b) a layer of polymer emulsion and aggregate over the sealant layer;
c) whereby said layer of polymer emulsion and aggregate shields said sealant layer from sunlight; and
d) a second sealer over said polymer emulsion and aggregate layer for protecting said polymer emulsion and aggregate layer from seawater.

12. The skid resistant coating as set forth in claim 11, wherein:
a) said first layer of sealant is epoxy.

13. The skid resistant coating as set forth in claim 11, wherein:
a) said aggregate is sand.

14. The skid resistant coating as set forth in claim 11, wherein:
a) said second sealer is xylene based.

15. The skid resistant coating as set forth in claim 14, wherein:
a) said second sealer is white.

16. The skid resistant coating as set forth in claim 11, wherein:
a) the surface on which the coating is applied is metal.

17. The skid resistant coating as set forth in claim 11, wherein:
a) said aggregate is sand.
